(19) United States
(12) Patent Application Publication
(10) Pub. No.: US 2004/0054621 A1
(43) Pub. Date: Mar. 18, 2004

(54) System and method for issuing and managing a portfolio of credit insurance policies

(76) Inventor: Gunnar Bretvin, Oslo (NO)

Correspondence Address: BIRCH STEWART KOLASCH & BIRCH, PO BOX 747, FALLS CHURCH, VA, 22040-0747, US

(21) Appl. No.: 10/416,853

(22) PCT Filed: Nov. 16, 2001
(86) PCT No.: PCT/NO01/00456

(30) Foreign Application Priority Data
Nov. 17, 2000 (NO) 20005848

(51) Int. Cl. G06F 17/60

(52) U.S. Cl. 705/38; 705/4

(57) ABSTRACT

A system embodied as a credit insurance company (103) for calculating and generating credit insurance policies is connected in a data communication network (120) and comprises interfaces providing links to one or more market places (101) offering financial services to customers and lenders, to at least one external database (109) providing information relating to market place(s) to customers (107) and lenders (108) operating independently thereof, and to at least one settlement handling system (106). The system comprises a first module (201) for issuing umbrella cover policies for customers and registering of securities, a second module (202) for handling a change request from a customer, a third module (203) for maintaining umbrella cover policies, a fourth module (204) for issuing actual cover policies to lenders, a fifth module (205) for executing change transactions, a sixth module (206) for communicating instructions and data for updating market place (101) databases, a seventh module (207) for claims handling and settlement, and an eighth module (208) for managing reinsurance of credit insurance policies. A method in the system comprises steps for receiving information from a market place, or an independent lender and relating to a customer applying for a loan, accessing information relating to the customer, determining a customer's borrowing capacity, issuing an umbrella credit insurance policy for an amount corresponding to the determined borrowing capacity, and determining terms relating to the issued policy.

The present invention concerns a system embodied as a credit insurance (financial guarantee) company for calculating and generating credit insurance policies, connected in a data communication network and comprising one or more interfaces providing links to one or more market places offering financial services to customers and lenders operating in the market place, to at least one external database providing credit and property information relating to the customers of a market place as well as information relating to credit companies and lenders, to customers and lenders operating independently of any market place, and to at least one settlement handling system providing secure transfers of funds in connection with handling the collection and payment of loans as provided by the credit insurance company; as well as a method in system of this kind.

The present invention particularly concerns a corporate system and methods for providing Umbrella Credit Insurance risk covers and for managing a portfolio of Credit Insurance Policies a Borrower needs an easily transferable collateral to obtain loans via open, shared networks like the Internet or in a closed, dedicated networks like Netbanks, and where a such customer wants the flexibility to replace one lender with another in an in-expensive and secure transaction. The invention also concerns a corporate system and methods for automated issuance of Actual Cover Credit Insurance policies under such Umbrella Credit Insurance Covers and for managing a portfolio of credit insurance policies issued to lenders to cover the actual lending risk via shared resources networks such as the Internet or in closed, dedicated networks such as a netbank. Furthermore the invention concerns a system and methods for reinsuring the combined risk of the said 2 credit insurance policy portfolios.

The invention relates generally to commerce with secured loans through intermediaries and the need for a new financial instrument that will allow easy and in-expensive transfers of loans from one lender to another in shared resources networks (such as the Internet) and other closed, dedicated networks (such as Netbanks). The rapidly expanding Internet financial services commerce where particularly market places specializing in intermediating secured loans and Netbanks dedicated to one particular banking system see an increased need for new financial instruments that will facilitate the transfer of such financial services between lenders in inexpensive, simple and secure transactions. It has been the inventor's objective to develop an instrument that simultaneously give the borrower a high degree of freedom to choose the most favourable and suitable terms in the market and be able to so at low change costs and that give the financial services industry an instrument that allows inexpensive lending with a secure collateral.

Although there is a vast number of borrowers, lenders and intermediaries giving ground to a fast growth in the volume of intermediated loans, only a small potential of these new market channels' capacity has yet been realized. National and International legislators over the world have firmly focused on the need for new financial instruments to enhance the domestic and the cross-border competition and on the consumers' need to have a real choice in the market place.

Today a typical, secured loan such as a home loan will be issued by a lender against security in the borrowers personal asset(s) such as a residential home. If the borrower wants to change lender, the security has to be re-established by the new lender, which is a costly and time-consuming procedure for the borrower as well as the lender. The collateral will usually remain at its original value with the lender and the securitized asset will tie up the borrower's capacity to take up other secured loans, such as a car loan, even if the original loan has been partly redeemed over time. Generally, the establishing of collateral is a costly and time-consuming procedure for a lender including the potential of making formal and informal mistakes.

The present invention relates generally to the fast growing commerce in market places acting as intermediaries between borrowers and lenders in shared resources networks such as the internet or in closed, dedicated networks such the Netbanks and particularly to issuing and managing portfolios of credit insurance policies to the secured or collateralized loan or mortgage commerce.

A first object of the present invention thus is to allow once for all establishing of a security (collateral) for a borrower as long as he chooses to remain a credit insurance policy holder or fulfill the requirements to remain one, that will be deemed as good as a conventional real estate backed security for a lender. Furthermore it gives the customer the option to change lenders at inexpensively either by his own initiative or being a member or participant in a market place particularly able to execute such automated transactions. The present invention necessitates the systems and methods described for the financial instrument described in this invention to utilize its full potential.

A second object of the present invention is to generate and issue credit insurance policies to give borrowers a financial instrument that rationalizes and economizes his borrowing by offering a prime security to lenders and to make it cost-wise feasible to change lender. Furthermore it enables the borrower to participate in intermediary market places or to borrow from Netbanks in shared resources networks like the Internet or in closed, dedicated networks based on an already established security constituting an easily acceptable security risk for a potential lender.

A third object of the present invention is to rationalize the procedures for establishing secured loans for lenders, particularly for those lenders actively participating in commerce in shared resources networks such as the Internet or in closed dedicated networks such the Netbanks. The cost of acquiring a new customer for secured loans backed by real estate are usually high and the present invention will dramatically reduce these costs. At the same time the present invention can rationalize other lending products like autoloans and personal credit lines as any unused borrowing capacity under the customers umbrella credit insurance policy now can used as security for such lending almost without new establishing costs. This also will usually give the borrower far better terms on such loans.

A fourth object of the present invention is to generate and issue credit insurance policies to give a lender a financial instrument that rationalizes and economizes his lending regarding administrative procedures, risk as well as in customer acquisition costs.

The present invention furthermore meets several objectives in giving a borrower better control over his loans. Firstly he can now to replace one lender with another if the terms of the latter are more favourable, without having to re-establish his collateral incurring unnecessary fees and charges. Consequently the invention is ideal for a customer who wants to participate in a market place such as seen on shared resources networks such as the Internet where many lenders offer their loans at different market places (intermediaries). The present invention makes it easy and secure to transfer a loan to the lender with the most favourable and suitable lending terms at any time. The invention is particularly well suited for market places using a system with interactive models to make automatic transactions.

A final objective of the present invention is to offer lenders who are active in net-business a new financial instrument where they can lend against a recognized, prime security at very low establishing and administration costs using the described new financial instrument as an tool to grow profitable, low-risk lending business.

The present invention is using a dual credit insurance policy system that is structured to give rational and favourable reinsurance terms by rationalizing and packaging the total risk exposures of the two credit insurance portfolios.

Furthermore the present invention is constructed in such a way that the reinsurance market institutes will further reduce the actual costs carried by reinsuring the aggregate portfolio risk compared with the risks in a loan portfolio in a lending institute.

The Credit Insurance system automates many steps in the credit review and approval process and using the capacity of the new networks it will dramatically reduce the expenses and risks in today's procedures of managing lending risks.

The above objects as well as further advantages and features are achieved with a system according to the present invention, and characterized in comprising a first system module for issuing umbrella cover policies for customers and registering of securities, said first system module being connected to the at least one external database and a system database for updating customer profiles, a second system module connected with the first system module for handling a change request from a customer in regard of an existing loan registered in said system database, a third system module for maintaining umbrella cover policies and connected with said at least one external database for accessing information including credit rating, said third system module being connected with said first system module via said system database, a fourth system module for issuing actual cover policies to lenders and connected to the first system module, via said system database, a fifth system module for executing change transactions including change of lender and change in terms from a particular lender, said fifth system module being connected with said first system module via said system database and partly integrated in said fourth system module, a sixth system module for communicating instructions and data for updating market place databases, including bookkeeping and updating of systems for executing payments, said sixth system module being connected via said system database respectively to the claim solution unit of the third module and the accounting process unit of the fourth and fifth system modules and via the latter with said at least one settlement handling system, a seventh system module for claims handling and settlement to lenders in case of a default, said seventh system module being connected with a review and/or claim unit of said second system module and with the update customer profile/history unit of the sixth system module, and an eighth system module for managing reinsurance of credit insurance policies, said eight system module being integrated in the first system module and comprising the create/update the actual umbrella cover and security unit thereof connected with respectively the create temporary umbrella unit thereof as well as said system database.

Advantageously the system according to the invention is connected in a shared resource network, such as Internet, or in a closed dedicated network, such as a banking network.

The above objects as well as further advantages and features are also achieved with a method according to the invention and characterized by comprising steps for

a) receiving information from a market place acting as an intermediary or a lender independent of the market place and relating to a pre-approved potential customer applying for a loan, said information including personal income data and assets in the form of personal property and valuables;

b) accessing information relating to the pre-approved potential customer, said information including data about credit worthiness and the location value of property from external databases;

c) determining a customer's borrowing capacity based on submitted, accessed and required information;

d) issuing an umbrella credit insurance policy for an amount corresponding to the determined borrowing capacity, and

e) determining terms relating to the issued policy, including policy start date, the policy end date, policy duration and policy premium. a) receiving information from a market place acting as an intermediary, or a lender independent of the marketplace relating to a pre-approved potential customer applying for a loan, said information including personal income data and assets in the form of personal property and valuables;

b) accessing information relating to the pre-approved potential customer, said information including data about credit worthiness and the location value of property from external databases;

c) determining a customer's borrowing capacity based on submitted, accessed and required information;

d) issuing an umbrella credit insurance policy for an amount corresponding to the determined borrowing capacity, and

e) determining terms relating to the issued policy, including policy start date, the policy end date, policy duration and policy premium.

Advantageously the method comprises an additional step for storing the policy and information relating thereto in a system database, and in that connection preferably also a further step for issuing an actual cover credit insurance policy to a lender.

In connection with the latter step it is preferred either separately or in combination to adjust the information including terms related to said umbrella credit insurance policy stored in the system database being adjusted with data stored in the actual cover policy account, associating a lender's actual cover credit insurance policy with an account in a market place database or in a lender's database, and insuring the aggregated risk of the portfolio of the umbrella cover policy, and the actual cover insurance policy.

In the method according to the invention it is considered advantageous with an additional step for associating a customer's credit insurance policy with an account in a market place or an account in a lender's database, and then it is preferred to associate a customer's credit insurance policy with an account in a market place or a lender's payment system.

Finally there is in the method according to the invention considered advantageous with a step for monitoring credit worthiness by accessing external databases, including databases of credit information agencies and property evaluation specialists as well as market place databases or a lender's databases and in that connection it is preferred to upgrade a customer's borrowing capacity by accessing external databases, including databases of credit information agencies and property evaluation specialists, market places or lenders.

The invention shall now be explained in more detail with reference to exemplary embodiments of the inventive system and its modules as well as the inventive method used therein and with reference to the appended drawing figures, in which

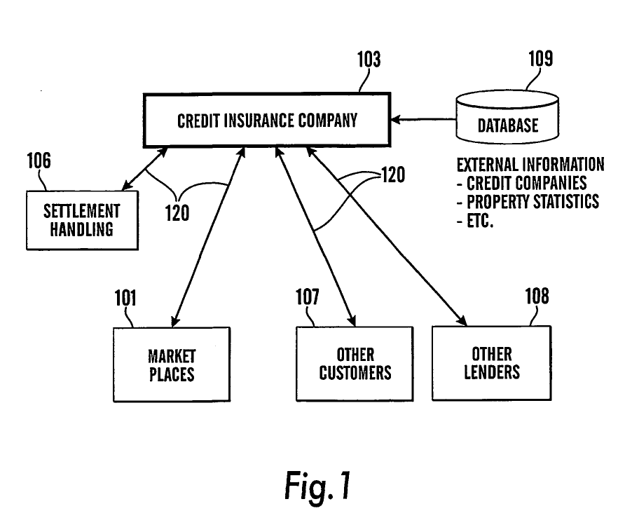

FIG. 1 shows the system according to the invention embodied as a credit insurance company and with communication links to interfacing entities and operations,

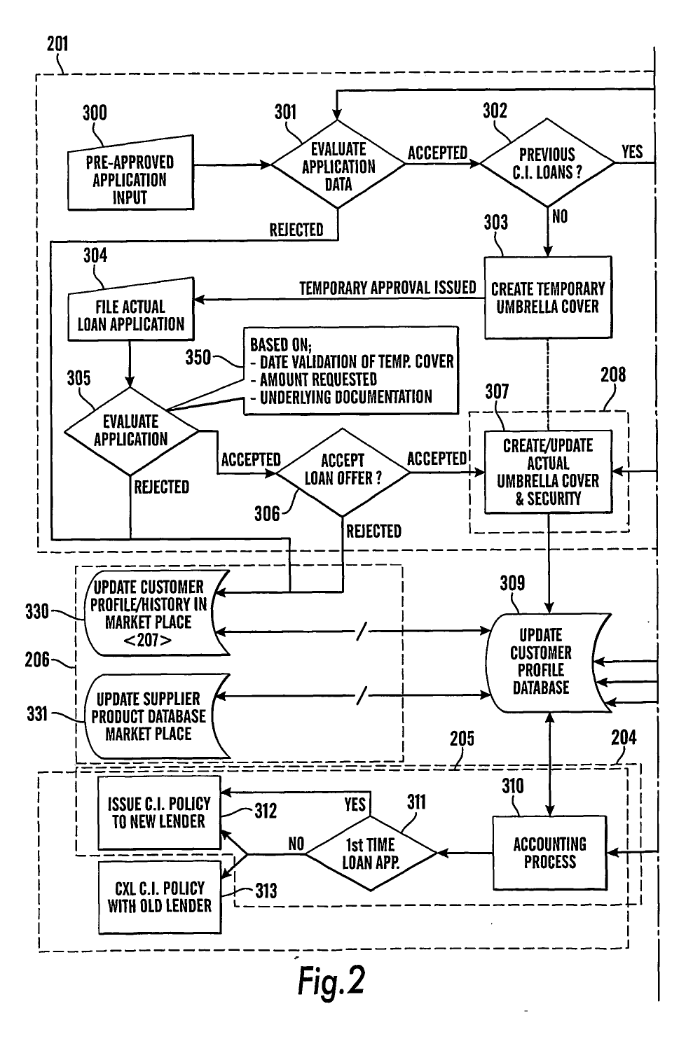

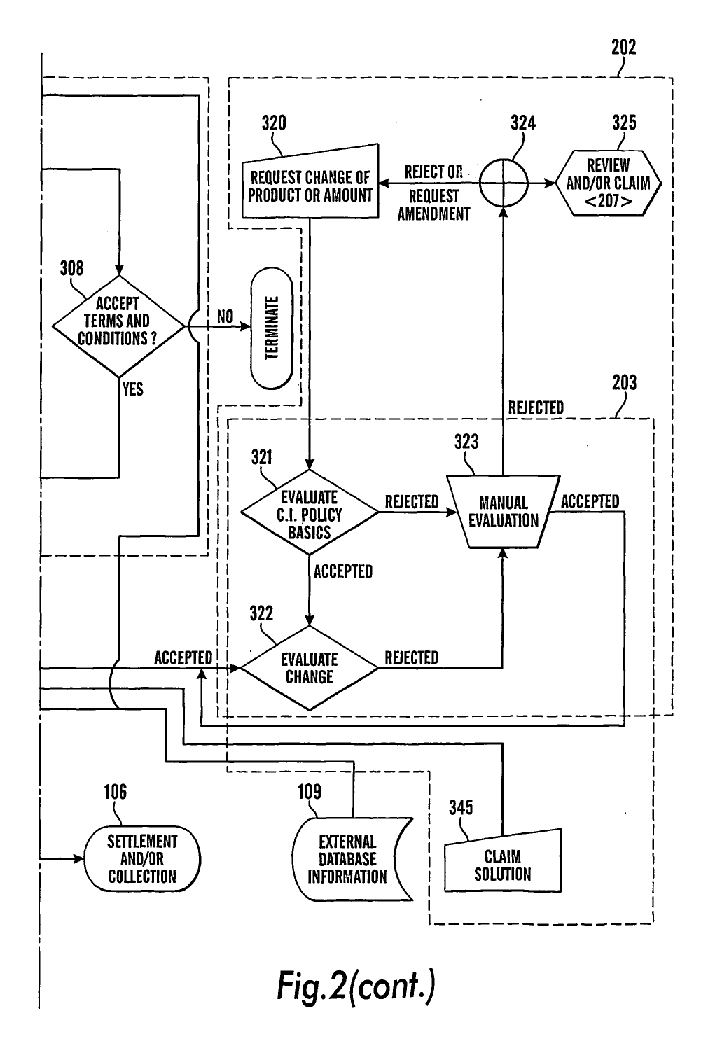

FIG. 2 a block diagram giving an overview of the system according to the invention,

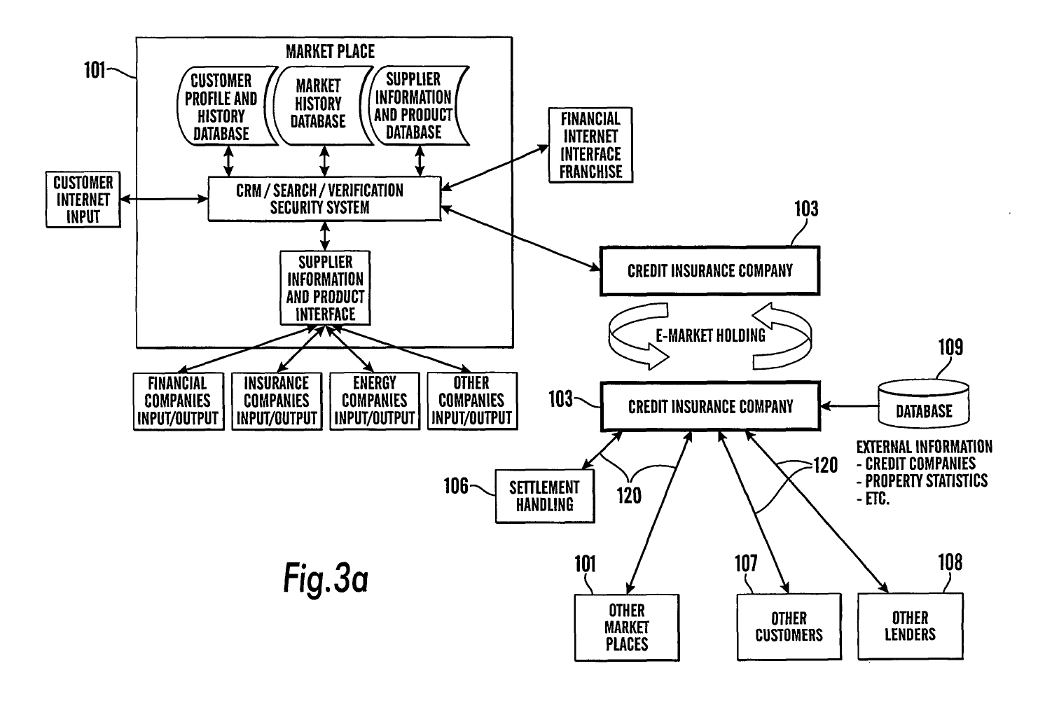

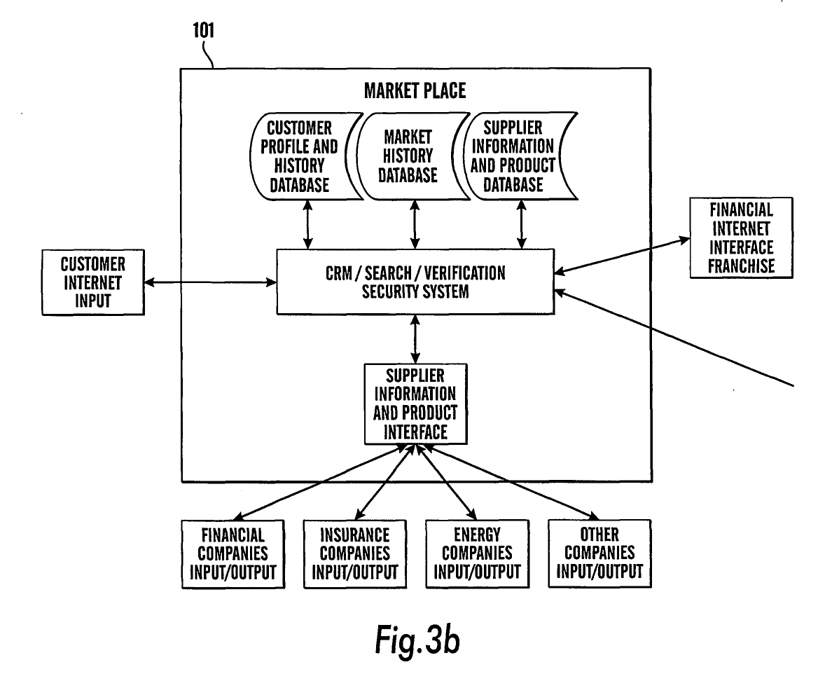

FIG. 3a a block diagram of the connection between the market place and the system according to the invention,

FIG. 3b in more detail the market place in FIG. 3a,

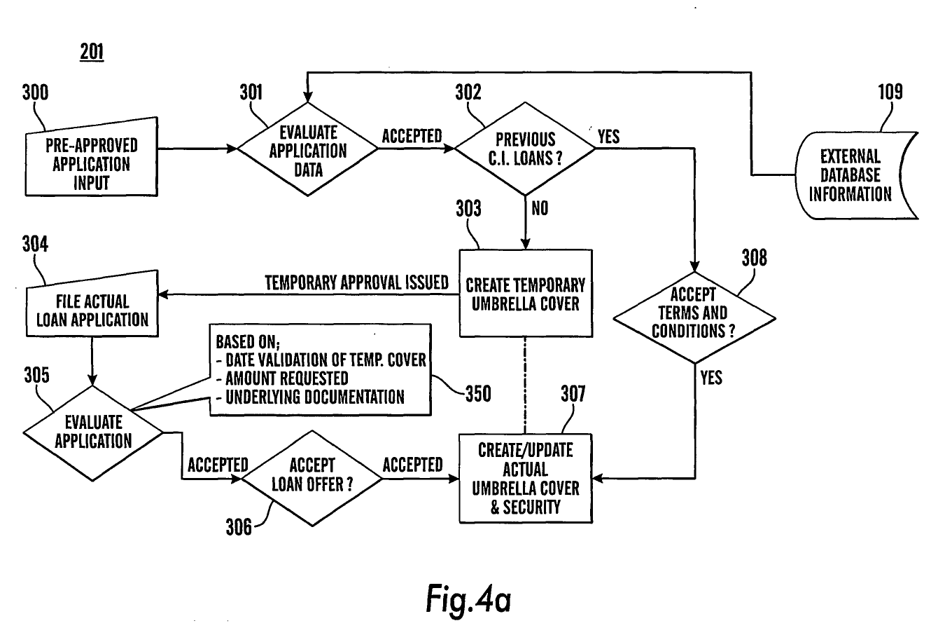

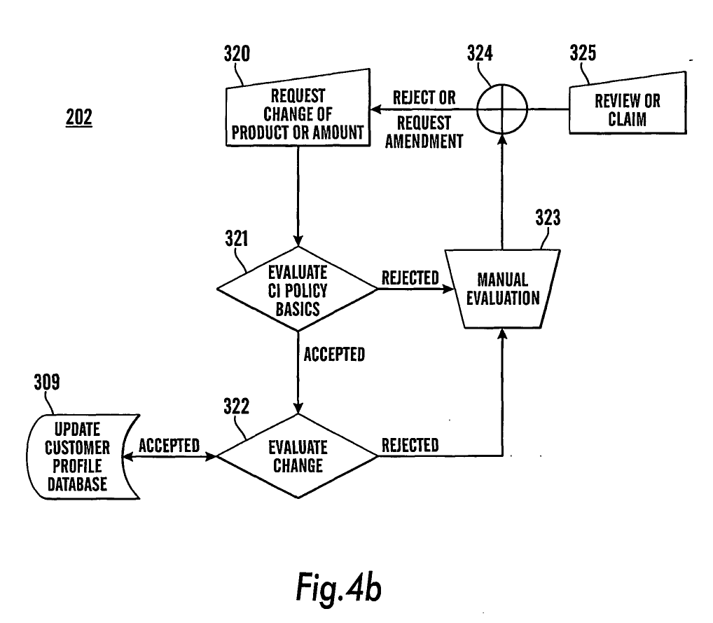

FIG. 4a a first module in the system according to the invention,

FIG. 4b a second module in the system according to the invention,

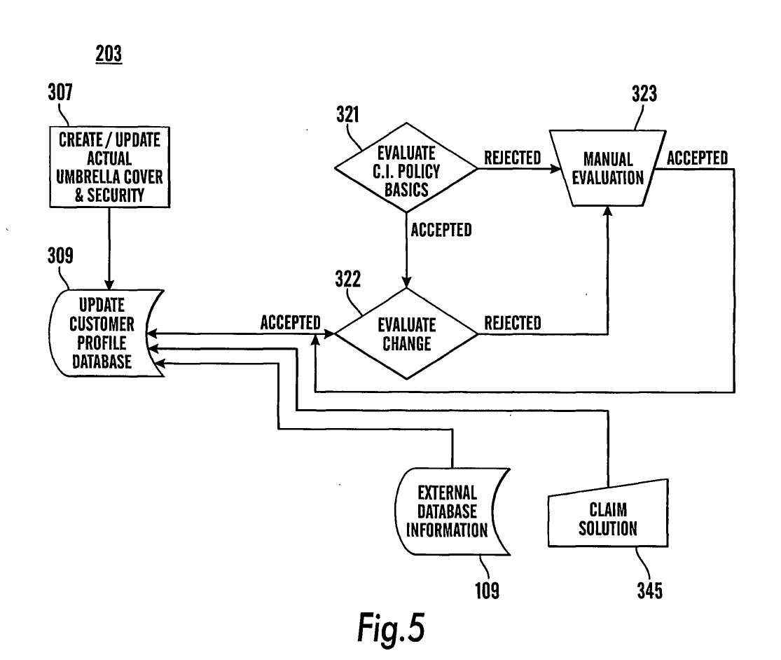

FIG. 5 a third module in the system according to the invention,

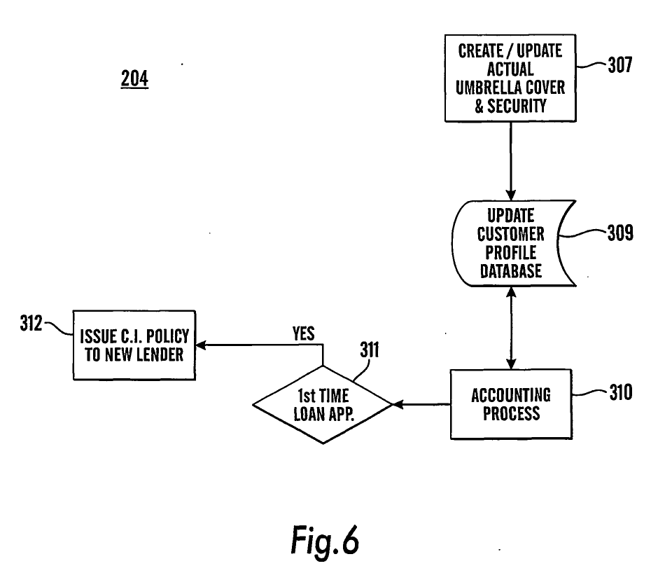

FIG. 6 a fourth module in the system according to the invention,

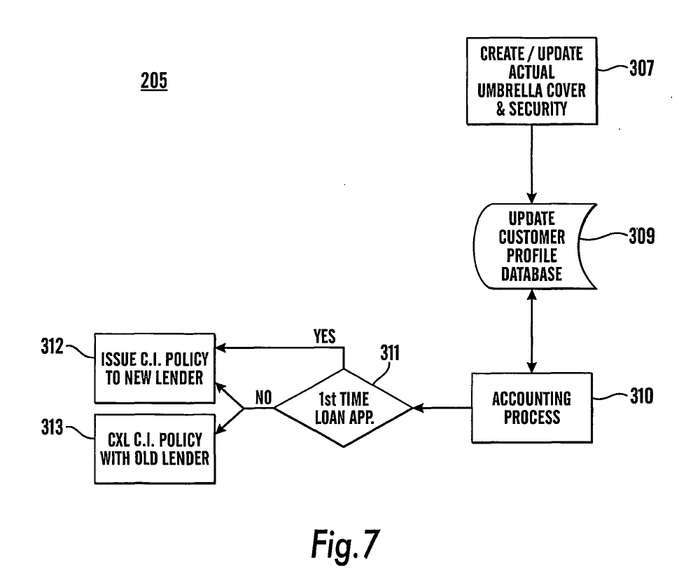

FIG. 7 a fifth module in the system according to the invention,

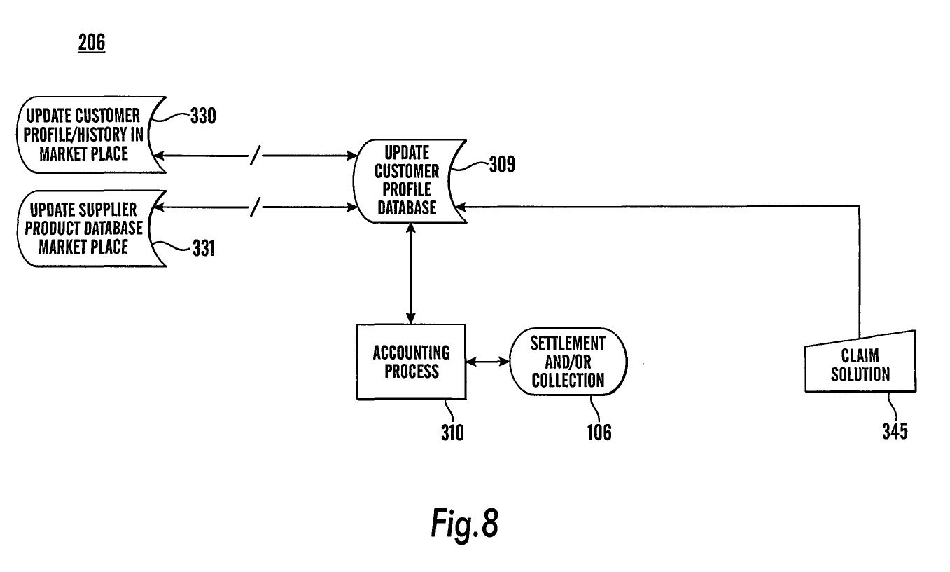

FIG. 8 a sixth module in the system according to the invention,

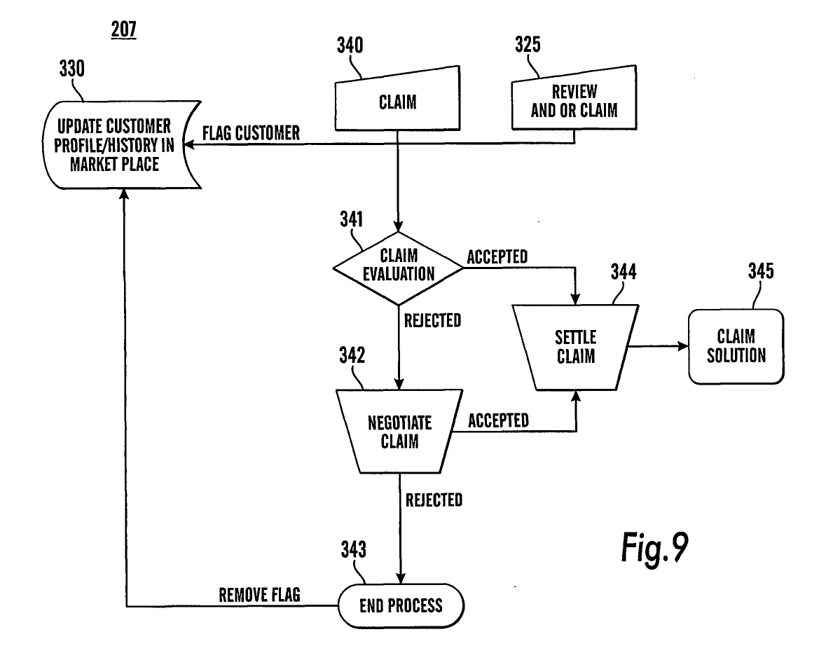

FIG. 9 a seventh module in the system according to the invention, and

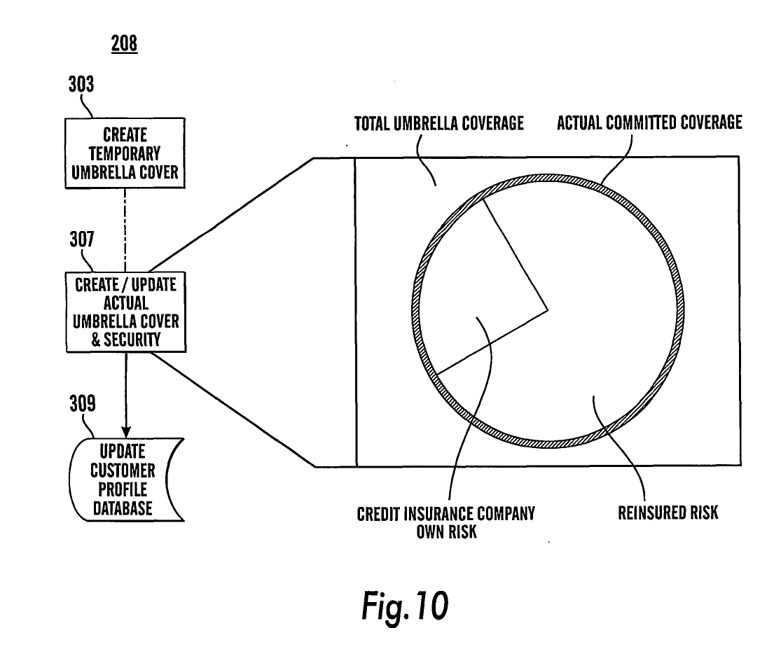

FIG. 10 an eighth module in the system according to the invention.

FIG. 1 is an example of an online network for practicing the present invention. In particular, a Market Place 101 offering financial services communicates with a server 103 within the Credit Insurance Company by means of a network 120, such as the World Wide Web portion of the Internet or other established and secure networks. In particular in interaction with Settlement Handling 106, already established secure networks between bank to handle monetary transfers of funds are in place.

The Credit Insurance Company 103 has established fixed communication with external Databases 109 providing credit and property data related to potential customers using the Market Place 101 to apply for loans using the services of the Credit Insurance Company 103. Other Customers 107 and Other Lenders 108 can also interact directly with the Credit Insurance Company 103 through similar networks 120 independently of the Market Place 101.

A communication system between the Credit Insurance Company 103 and an entity, Settlement Handling 106, is establish to handle the collection and payment of loans as provided by the Credit Insurance Company 103.

Now an outline of the system according to the invention shall be given with reference to FIGS. 2, 3a and 3b, of which FIGS. 3a and 3b give an overview of the interaction between the various modules of the system of the invention and how it is connected to the market place, which is shown in details in FIG. 3b.

Particularly FIG. 2 exemplifies the procedures and methods in the Credit Insurance Company for practicing the present invention, showing the system modules and their interconnections with particular exception of module 207 as well as the database 309. In addition FIG. 2 also shows the functional units of the system modules and the interconnection of the former within the system modules.

In particular, a Pre-Approved loan application is received from a Market Place 101 at Pre-Approved Application Input 300. The application is automatically processed through the Evaluate Application Data 301 unit using data from the External Database Information 110 and if rejected automatically returned to the client 100 through the Update Customer Profile/History in Market Place 330. If the application is accepted by the accepted the Evaluate Application Data 301 unit the system determines if the customer has Previous Credit Insurance Loans 302. If no previous record is established the Credit Insurance Company 103 the system will Create Temporary Umbrella Cover 303 and automatically start the process File Actual Loan Application 304. The application will then be evaluated in the Evaluate Application 305 based on the various parameters as outline in 350. If rejected the system will automatically return the result to the customer through the Update Customer Profile/History in Market Place 330. If the Evaluate Application 305 is accepted the customer will be asked to Accept Loan Offer 306. If he rejects the actual offer the system will automatically return the result to the customer through the Update Customer Profile/History in Market Place 330. If the Accept Loan Offer 306 is accepted by the customer the process Create/Update Actual Umbrella Cover and Security 307 will be processed.

If the customer in Previous Credit Insurance Loan 302 process is determined to have an established account with the Credit Insurance Company 103 the customer will be requested to Accept Terms and Conditions 308 for the loan otherwise the system will automatically Terminate 309 the process. If the customer Accept Terms and Conditions 308 the system will Create/Update Actual Umbrella Cover and Security 307.

After the Create/Update Actual Umbrella Cover and Security 307 has been processed the clients account will be updated in the Updated Customer Profile Database 309.

Once the Updated Customer Profile Database 309 has been updated it will in turn Update Customer Profile History in Market Place 330 and Update Supplier Product Database in Market Place 331. This will ensure that the data, in the two previously noted entities in the Market Place 101, are updated with current information pertaining to the status of the customer in the Credit Insurance Company 103 in relation to Total Umbrella Cover (Total Risk Committed) and Actual Umbrella Cover (Actual Risk Committed).

Furthermore the Updated Customer Profile Database 309 will further relate relevant information to the Accounting Process 310. This is where bookkeeping is maintained, who in turn automatically will advise the Settlement and/or Collection 106 unit connected to the Credit Insurance Company 103. The Settlement and/or Collection 106 units will process the actual collection and payment of funds to the relevant lenders involved in the transaction. At the same time the Accounting Process 310 will verify if this is a 1.st Time Loan Application 311. If it is, a Credit Insurance Policy will be issued to the lender through the Issue Credit Insurance Policy to New Lender 312. If the customer has a previous loan a the system will Issue Credit Insurance Policy to New Lender 312 and at the same time send a cancellation of a policy to the old lender through the CLX Credit Insurance Policy with Old Lender 313.

The Update Customer Profile Database 309 is also automatically updated by the External Database Information 109 which includes information from entities like Credit Rating Companies and Property Evaluation resources. The Update Customer Profile Database 309 is also automatically updated by the claim Solution 345 as outlined in the diagram under (ref. FIG. 9).

FIG. 4a shows the first and main system module 201 which implements the system and method in respect of issuing umbrella cover policies (based on pre-approved customer from the market place) including registration of security(ies) for practicing the present invention.

In particular, a Pre-Approved loan application is received from a Market Place 101 at Pre-Approved Application Input 300. The application is automatically processed through the Evaluate Application Data 301 unit using data from the External Database Information 110 and if rejected automatically returned to the client 100 through the Update Customer Profile/History in Market Place 330. If the application is accepted by the accepted the Evaluate Application Data 301 unit the system determines if the customer has Previous Credit Insurance Loans 302. If no previous record is established the Credit Insurance Company 103 the system will Create Temporary Umbrella Cover 303 and automatically start the process File Actual Loan Application 304. The application will then be evaluated in the Evaluate Application 305 based on the various parameters as outline in 350. If rejected the system will automatically return the result to the customer through the Update Customer Profile/History in Market Place 330. If the Evaluate Application 305 is accepted the customer will be asked to Accept Loan Offer 306. If he rejects the actual offer the system will automatically return the result to the customer through the Update Customer Profile/History in Market Place 330. If the Accept Loan Offer 306 is accepted by the customer the process Create/Update Actual Umbrella Cover and Security 307 will be processed.

If the customer in Previous Credit Insurance Loan 302 process is determined to have an established account with the Credit Insurance Company 103 the customer will be requested to Accept Terms and Conditions 308 for the loan. If the customer Accept Terms and Conditions 308 the system will Create/Update Actual Umbrella Cover and Security 307.

On occasions it will be required to make changes in existing loans. This can be handled by system module 202, as shown in FIG. 4b, which now shall be explained in detail.

If the customer is making a change request to an existing loan already registered in the Update Customer Profile Database 309, a request from the Market Place 101 will be submitted through the Request Change of Product or Amount 320. The request will automatically be processed by the Evaluate Credit Insurance Policy Basics 321, determining of the change request meets some basic requirements in order to be further processed. If accepted the system will in Evaluate Change 322 request obtain information from the Updated Customer Profile Database 309 before approving the change request and returning the accept reply with relevant information to the Updated Customer Profile Database 309. In the event Evaluate Change 322 is rejected the request is returned to the Manual Evaluation 323 where the request is manually processed. Similarly a rejected Evaluate Credit Insurance Policy Basic is rejected it is also forwarded to Manual Evaluation 323 where the request is manually processed. The Manual Evaluation 323 units accept the request the Update Customer Profile Database 309 is updated otherwise the request is forwarded to 324 where the rejection is determined to be of one of two types. The customer is either advised to modify the request and submit a new Request Change of Product or Amount 320 application or in specific cases the request may have uncovered information causing the information to be forwarded for further Review and/or claim (ref. Claim process 340).

The third system module 203 is shown in detail in FIG. 5. FIG. 5 is an example of how the systems is implemented for maintaining the umbrella cover policies linked to such external systems as credit rating and zoning property valuation for practicing the present invention.

After the Create/Update Actual Umbrella Cover and Security 307 has been processed the clients account will be updated in the Updated Customer Profile Database 309.

On the other hand if a request for a change has been submitted the request will automatically be processed by the Evaluate Credit Insurance Policy Basics 321, determining of the change request meets some basic requirements in order to be further processed. If accepted the system will in Evaluate Change 322 request obtain information from the Updated Customer Profile Database 309 before approving the change request and returning the accept reply with relevant information to the Updated Customer Profile Database 309. In the event Evaluate Change 332 is rejected the request is returned to the Manual Evaluation 323 where the request is manually processed. Similarly a rejected Evaluate Credit Insurance Policy Basic is rejected it is also forwarded to Manual Evaluation 323 where the request is manually processed. If the Manual Evaluation 323 unit accepts the request the Update Customer Profile Database 309 is updated.

The Update Customer Profile Database 309 is also automatically updated by the External Database Information 109 that includes information from entities like Credit Rating Companies and Property Evaluation resources. The Update Customer Profile Database 309 is also automatically updated by the claim Solution 345 as outlined in the diagram under (ref. FIG. 9).

The fourth system module 204 is shown in detail in FIG. 6.

FIG. 6 is an example of how the system is implemented for issuing actual cover policies to lenders (linked to the system for issuing umbrella covers for practicing the present invention. If a loan offer is accepted by the customer the system will Create/Update Actual Umbrella Cover and Security 307. After the Create/Update Actual Umbrella Cover and Security 307 has been processed the customers account will be updated in the Updated Customer Profile Database 309. Furthermore the Updated Customer Profile Database 309 will then relate relevant information to the Accounting Process 310. This is where bookkeeping is maintained and at the same time the Accounting Process 310 will verify if this is a 1.st Time Loan Application 311. If it is, a Credit Insurance Policy will be issued to the lender through the Issue Credit Insurance Policy to New Lender 312.

The fifth system module is shown in detail in FIG. 7.

FIG. 7 is an example of how the system is implemented for executing change transactions such as change of lender and change in terms from one particular lender for practicing the present invention. If a loan offer is accepted by the customer the system will Create/Update Actual Umbrella Cover and Security 307. After the Create/Update Actual Umbrella Cover and Security 307 has been processed the customers account will be updated in the Updated Customer Profile Database 309. Furthermore the Updated Customer Profile Database 309 will then relate relevant information to the Accounting Process 310. This is where bookkeeping is maintained and at the same time the Accounting Process 310 will verify if this is a 1.st Time Loan Application 311. If it is not, the system will Issue Credit Insurance Policy to New Lender 312 and at the same time send a cancellation of a policy to the old lender through the CLX Credit Insurance Policy with Old Lender 313. When there is only a change in amount, the old and new lender is the same. Regardless a cancellation of old policy and issuing of new policy will take place.

The sixth system module 206 is shown in detail in FIG. 8.

FIG. 8 is an example of how the system is implemented for communicating instructions and data to the market place systems such as booking and updating of the payment system for practicing the present invention. Once the Updated Customer Profile Database 309 has been updated it will in turn Update Customer Profile History in Market Place 330 and Update Supplier Product Database in Market Place 331. This will ensure that the data, in the two previously noted entities in the Market Place 101, are updated with current information pertaining to the status of the customer in the Credit Insurance Company 103 in relation to Total Umbrella Cover (Total Risk Committed) and Actual Umbrella Cover (Actual Risk Committed).

Similarly a claim Solution 345 will result in Update Customer Profile Database 309 automatically being modified.

Both these incidents will require trigger the Updated Customer Profile Database 309 to relate relevant information to the Accounting Process 310. This is where bookkeeping is maintained, who in turn automatically will advise the Settlement and/or Collection 106 unit connected to the Credit Insurance Company 103. The Settlement and/or Collection 106 unit will process the actual collection and payment of funds to the relevant lenders involved in the transaction.

The seventh system module 207 is shown in detail in FIG. 9, but is partly left out in the overview in FIG. 2.

FIG. 9 is an example of how the system is implemented for claims handling and claims settlements to lenders in case of default for practicing the present invention. In the system a Claim 340 from lenders or from internal Review and/or Claim 325 is processed through the automated claim Evaluation 341.

The system will at the same time will Flag Customer through the Update Customer Profile/History 330 in the Market Place 101 ensuring the customer is advised of the pending claim. If the claim is rejected in the claim Evaluation 341 the claim will present to the manual Negotiate Claim 342 for review. If again rejected the Remove Flag will be sent to the Update Customer Profile/History 330 in the Market Place 101 ensuring the customer is released from claim. If in either the claim Evaluation 341 or the Negotiate Claim 342 process the claim is accepted the Settle Claim 344 will be processed that will issue a claim Solution 345 to the Update Customer Profile Database 309 in the Credit Insurance Company 103.

The eighth system module 208 is shown in detail in FIG. 10.

FIG. 10 is an example of how the system is implemented for managing the reinsurance for practicing the present invention. Based on the information maintained by the Create/Update Actual Umbrella Cover & Security 307, the system will maintain records of Total Umbrella Coverage (offered) and Actual Committed Coverage (used). The system will automatically maintain a situation where approximately 75% of the Actual Committed Coverage (Risk) is reinsured through other external entities and approximately 25% of the Actual Committed Coverage (risk) is maintained by the Credit Insurance Company 103.

The invention automates many steps in the traditional credit review and approval procedures and utilizing the capacity of shared resources networks such as the Internet, it dramatically reduces the expenses and risks compared with the present procedures of handling lending risks. Using the Internet's capacity for inexpensive linkage to other databases it will automate and rationalize the maintenance and development of the borrowers credit worthiness and automatically adjust the lending values of the collateralized assets. The present invention includes updating the policyholders borrowing capacity over time accessing other databases as well as processing input data from the policyholder.

One application is to assist a customer in a market place to obtain a secured loan on favourable terms from a lender and to replace the conventional expensive procedure securing this loan with a new inexpensive procedure.

Another application can be to provide an inexpensive, first rate security to lenders that also may improve the yield of their lending.

Many countries have taxes, charges and fees on the establishing of collateral of a secured loan. When a lender is replaced and the loan transferred to a new lender or if a loan is refinanced, such taxes, charges and fees are often again fully incurred. By using the new financial instrument described in the present invention such taxes or fees are either avoided or dramatically reduced.

1. A system embodied as a credit insurance (financial guarantee) company (103) for calculating and generating credit insurance policies, connected in a data communication network (120) and comprising one or more interfaces providing links to one or more market places (101) offering financial services to customers and lenders operating in the market place, to at least one external database (109) providing credit and property information relating to the customers of a market place as well as information relating to credit companies and lenders, to customers (107) and lenders (108) operating independently of any market place, and to at least one settlement handling system (106) providing secure transfers of funds in connection with handling the collection and payment of loans as provided by the credit insurance company, the system being
characterized in comprising
a first system module (201) for issuing umbrella cover policies for customers and registering of securities, said first system module (201) being connected to the at least one external database (109) and a system database (309) for updating customer profiles,
a second system module (202) connected with the first system module (201) for handling a change request from a customer in regard of an existing loan registered in said system database (309),
a third system module (203) for maintaining umbrella cover policies and connected with said at least one (109) external database for accessing information including credit rating, said third system module (203) being connected with said first system module (201) via said system database (309), and
a fourth system module (204) for issuing actual cover policies to lenders and connected to the first system module (201) via said system database (309).

2. A system according to claim 1,
characterized in comprising a fifth system module (205) for executing change transactions including change of lender and change in terms from a particular lender, said fifth system module (205) being connected with said first system module (201) via said system database (309) and partly integrated in said fourth system module (204).

3. A system according to claim 2,
characterized in comprising a sixth system module (206) for communicating instructions and data for updating market place (101) databases, including bookkeeping and updating of systems for executing payments, said sixth system module being (206) connected via said system database (309) respectively to the claim solution unit (345) of the third module (203) and the accounting process unit (310) of the fourth and fifth system modules (204, 205) and via the latter with said at least one settlement handling system (106).

4. A system according to claim 3,
characterized in comprising a seventh system module (207) for claims handling and settlement to lenders in case of a default, said seventh system (207) module being connected with a review and/or claim unit (325) of said second system module (202) and with the update customer profile/history unit (330) of the sixth system module (206).

5. A system according to claim 1,
characterized in comprising an eighth system module (208) for managing reinsurance of credit insurance policies, said eight system module being integrated in the first system module (201) and comprising the create/update the actual umbrella cover and security unit (307) thereof connected with respectively the create temporary umbrella unit (303) thereof as well as said system database (309).

6. A system according to claim 1,
characterized in being connected in a shared resources network, such as Internet.

7. A system according to claim 1,
characterized in being connected in a closed and dedicated network, such as a banking network.

8. A method in a system embodied as a credit insurance (financial guarantee) company (103) for calculating and generating credit insurance policies, connected in a data communication network (120) and comprising one or more interfaces providing links to one or more market places (101) offering financial services to customers and lenders operating in the market place, to at least one external database (109) providing credit and property information relating to the customers of a market place as well as information relating to credit companies and lenders, to customers (107) and lenders (108) operating independently of any market place, and to at least one settlement handling system (106) providing secure transfers of funds in connection with handling the collection and payment of loans as provided by the credit insurance company, and wherein the method is
characterized by comprising steps for
a) receiving information from a market place acting as an intermediary or a lender independent of the market place, and relating to a pre-approved potential customer applying for a loan, said information including personal income data and assets in the form of personal property and valuables;
b) accessing information relating to the pre-approved potential customer, said information including data about credit worthiness and the location value of property from external databases;
c) determining a customer's borrowing capacity based on submitted, accessed and required information;
d) issuing an umbrella credit insurance policy for an amount corresponding to the determined borrowing capacity, and
e) determining terms relating to the issued policy, including policy start date, the policy end date, policy duration and policy premium.

9. A method according to claim 8,
characterized by comprising a step for storing the policy and information relating thereto in a system database.

10. A method according to claim 8,
characterized by a step for issuing an actual cover credit insurance policy to a lender.

11. A method according to claim 10,
characterized by a step for adjusting the information including terms related to said umbrella credit insurance policy stored in the system database being adjusted with data stored in the actual cover policy account.

12. A method according to claim 10,
characterized by a step for associating a lender's actual cover credit insurance policy with an account in a market place database or in a lender's database.

13. A method according to claim 10,
characterized by a step for insuring the aggregated risk of the portfolio of the umbrella cover policy and the actual cover insurance policy.

14. A method according to claim 8,
characterized by comprising a step for associating a customer's credit insurance policy with an account in a market place or an account in a lender's database.

15. A method according to claim 8,
characterized by comprising a step for associating a customer's credit insurance policy with an account in a market place or a lender's payment system.

16. A method according to claim 8,
characterized by comprising a step for monitoring credit worthiness by accessing external databases, including databases of credit information agencies, property evaluation specialists, market places, or lenders.

17. A method according to claim 8,
characterized by comprising a step for upgrading a customer's borrowing capacity by accessing external databases, including databases of credit information agencies, property evaluation specialists, market places, or lenders.
